(19) United States
(12) Patent Application Publication
(10) Pub. No.: US 2025/0256419 A1
(43) Pub. Date: Aug. 14, 2025

(54) Food Slicing Device

(71) Applicant: Christopher Williams, Colorado Springs, CO (US)

(72) Inventor: Christopher Williams, Colorado Springs, CO (US)

(21) Appl. No.: 18/641,599

(22) Filed: Apr. 22, 2024

Related U.S. Application Data
(60) Provisional application No. 63/552,319, filed on Feb. 12, 2024.

(51) Int. Cl. B26D 7/22; B26D 1/15; B26D 5/20; B26D 7/00; B26D 7/06

(52) U.S. Cl. CPC B26D 7/225; B26D 1/15; B26D 5/20; B26D 7/0625; B26D 2007/0018; B26D 2210/02

(57) ABSTRACT

A food slicing device is disclosed for slicing meat and other foods in a thin, uniform manner. The food slicing device comprises a body component that is configured in a box-like enclosure for housing multiple circular blades within its interior. Further, the body component comprises a tapered opening on one side, which allows meat to be fed into the device and pushed flat against the circular blades. A feeder mechanism, which is a rolling tread, is used to move the meat through the circular blades. The device includes a power button, which rotates the circular blades, moves the feeder mechanism, and closes the tapered opening of the body component to protect a user. Users can insert meat into the tapered end and activate the device via the power button. The feeder mechanism is then activated and the meat is sent through the circular blades, and is sliced thinly.

### CROSS-REFERENCE TO RELATED APPLICATION

The present application claims priority to, and the benefit of, U.S. Provisional Application No. 63/552,319, which was filed on Feb. 12, 2024, and is incorporated herein by reference in its entirety.

### FIELD OF THE INVENTION

The present invention relates generally to the field of food slicing devices. More specifically, the present invention relates to a meat slicing tool capable of cutting meat and other foods into thin strips. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in food slicing devices. Generally, cutting meat and other foods can be a time-consuming process, especially when the meat/food needs to be sliced thin. Further, people may have difficulty slicing meat thin with a standard kitchen knife, and cutting meat by hand can be unsafe and lead to serious injuries.

To slice a food item, a cook typically holds the food item with one hand and holds a knife with the other hand. However, it may be difficult for the cook to hold the food item steadily in order to get a satisfactory cut. Furthermore, oftentimes each food item must be cut individually. There is also a risk of getting a cut finger or hand when trying to cut items, in particular small, oddly shaped, or fatty food items. A food slicing device that addresses these issues is desirable.

Accordingly, there is a demand for an improved food slicing device that is capable of cutting meat and other foods into thin strips. More particularly, there is a demand for a food slicing device that prevents users from having to cut meat and other foods by hand.

Therefore, there exists a long felt need in the art for a food slicing device that provides users with a meat and other food slicing tool capable of cutting meat into thin strips. There is also a long felt need in the art for a food slicing device that allows users to prepare meat cooked in Japanese-style dishes with ease. Further, there is a long felt need in the art for a food slicing device that features a power button that activates a feeder mechanism and blades. Moreover, there is a long felt need in the art for a device that allows users to place meat and other foods on the feeder mechanism and allow it to be sliced thinly via the blades. Further, there is a long felt need in the art for a food slicing device that prevents users from having to thinly cut meat and other foods by hand, which can be difficult and time consuming. Finally, there is a long felt need in the art for a food slicing device that can be used with meat and other foods.

The subject matter disclosed and claimed herein, in one embodiment thereof, comprises a food slicing device. The device is an electric cutting device for slicing meat and other foods in a thin, uniform manner. The food slicing device comprises a body component that is configured in a box-like enclosure for housing multiple circular blades within its interior. Further, the body component comprises a tapered opening on one side, which allows meat to be fed into the device and pushed flat against the circular blades. A feeder mechanism, which is a rolling tread, is used to move the meat through the circular blades. The device includes a power button, which rotates the circular blades, moves the feeder mechanism, and closes the tapered opening of the body component to protect a user. The device can be powered via batteries or a standard electrical outlet plug. Users can insert meat into the tapered end and activate the device via the power button. The feeder mechanism is then activated and the meat is sent through the circular blades, and is sliced thinly. The sliced meat is then expelled from the other side of the body component and onto a tray for subsequent handling or consumption.

In this manner, the food slicing device of the present invention accomplishes all of the forgoing objectives and provides users with a device that cuts meat into thin strips for cooking. The device prevents users from cutting meat by hand. The device can be used with meat and other foods.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a food slicing device. The device is an electric cutting device for slicing meat and other foods in a thin, uniform manner. The food slicing device comprises a body component for housing multiple circular blades within its interior. A feeder mechanism, which is a rolling tread, is used to move the meat through the circular blades. The device includes a power button, which rotates the circular blades, moves the feeder mechanism, and closes the tapered opening of the body component to protect a user.

In one embodiment, the food slicing device is a stand-alone unit of a conveniently small size which can be placed on a work surface, in a kitchen, in a household, or at some other location in the home, as desired. Alternatively, it can also be used in the meat section of a supermarket or grocery store.

In one embodiment, the food slicing device comprises a body component that is configured in a box-like enclosure for housing multiple circular blades within its interior. The body component can be any suitable shape and size as is known in the art, as long as the body component is sized to retain multiple circular blades within its interior. Specifically, the body component acts as a protective cover, to prevent injury from the blades, as well as to prevent any food from being ejected from the blades during the slicing process. Typically, the body component is configured in a rectangular shape, with a top surface, a bottom surface, opposing front and back walls, and opposing right and left side openings, which form an open interior. The opposing right and left side openings allow access to the interior.

In one embodiment, the body component comprises opposing right and left side openings, with the right side being a tapered opening for insertion of the meat or other food to be sliced. Further, the tapered opening allows meat to be fed into the device and pushed flat against the circular blades. Once the food is inserted through the tapered opening to be sliced, the tapered opening is automatically closed to prevent user injury from the active blades via a sliding door. The left side comprises an exit opening for expelling the sliced food. Typically, the exit opening comprises a tray for catching the sliced food, once it has passed through the body component.

In one embodiment, the body component houses multiple circular blades within its interior, wherein the circular blades are disc-like rotary blades. However, the circular blades can be any suitable blades as is known in the art. Further, any suitable number of blades can be utilized as is known in the art, as long as the blades are able to effectively cut the food that is being placed through the body component into the required thin slices. Typically, the multiple circular blades are secured within the interior via an axle positioned through the center of the circular blades, which attaches by its ends to the interior sidewalls. Generally, the circular blades are of a rotary type. Specifically, the circular blades are rotatably mounted along a shaft that is generally parallel to the food's path through the body component.

In one embodiment, the bottom interior surface of the body component comprises a feeder mechanism, which is a rolling tread which engages the product and moves the same toward the circular blades. Specifically, the feeder mechanism is a generally horizontal platform which acts to propel the food through the body component to be sliced by the circular blades. A user would position the food onto the feeder mechanism, and the feeder mechanism would transport the food through the body component, as needed. Accordingly, food, such as meat, moves along the feeder mechanism until such product engages and is sliced by the circular blades in order to form individual slices which are then expelled onto the tray from the exit opening and form stacks of product slices for subsequent cooking and meal prep.

As is customary with a food slicing device such as that illustrated, the thickness of each slice will be a function of the speed at which the product is fed to the circular blades, which blades typically rotate at a constant speed. When the feeder mechanism moves the product into the circular blades at a relatively fast speed, then the thickness of each slice is relatively thick since the product moves across the plane of the blades for an extended length as compared with the length of movement through the plane of the blades when the product is moving at a slower speed which would form thinner slices.

In one embodiment, the food slicing device is a powered, automative food cutting device. The body component comprises a power button, typically positioned on a top surface but can be positioned in any suitable place on the body component. The power button powers on and off the device and acts to activate the motor to rotate the circular blades and activate the feeder mechanism to transport food through the body component, as well as to activate closing of the sliding door on the tapered opening.

In one embodiment, the food slicing device comprises a motor, which is preferably an electric motor for rotating the circular blades. Further, the body component comprises a controller connected to the motor to turn it on and off and control the motor speeds, if it's variable speed motor. In one embodiment, the motor is connected to the circular blades via a drive shaft. Specifically, the drive shaft is connected to an axel on the circular blades either directly or indirectly to rotate the circular blades.

In one embodiment, suitable drive mechanisms are provided including a main drive shaft, which is driven by the motor through a timing belt. The drive shaft extends into a drive box which contains a mechanism for rotating the axel of the cylindrical blades.

In one embodiment, the food slicer device comprises a power source of a plurality of batteries, preferably rechargeable batteries. In another embodiment, the power source is a standard electrical outlet plug. Specifically, the power source is controlled by a power switch which is in communication with the controller to control the motor to rotate the circular blades to slice the food.

In one embodiment, the food slicing device is manufactured of a metal, such as stainless steel or aluminum, or polymers, such as acrylonitrile butadiene styrene (ABS), polyurethane, etc. However, any other suitable food-grade materials (preferably of relatively light weight), such as galvanized, aluminum, polypropylene (PP) or polycarbonate (PC) may also be used.

In yet another embodiment, the food slicing device comprises a plurality of indicia.

In operation, users can insert meat into the tapered opening and activate the device via the power button. Once the power button is depressed, the feeder mechanism is activated and the meat is sent through the circular blades and is sliced thinly. Further, once the food is inserted through the tapered opening and the feeder mechanism is activated, the tapered opening is automatically closed via the sliding door. Once the meat is passed through the circular blades, the sliced meat is then expelled from the other side of the body component and onto a tray for subsequent handling or consumption.

In yet another embodiment, a method of automatically thinly slicing meat and other foods with ease is disclosed. The method includes the steps of providing a food slicing device comprising a body component with a circular blade and feeder mechanism. The method also comprises inserting meat into the body component. Further, the method comprises activating the device via the power button, which activates the circular blade and feeder mechanism. The method also comprises sending the meat through the circular blade for slicing via the feeder mechanism. Finally, the method comprises expelling the sliced meat from the body component and onto a tray for cooking.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the food slicing device of the present invention showing how meat is fed through the device in accordance with the disclosed architecture;

FIGS. 2A-B illustrate a perspective view of one embodiment of the food slicing device of the present invention showing how the tapered opening is closed upon activation in accordance with the disclosed architecture;

FIG. 3 illustrates a perspective view of one embodiment of the food slicing device of the present invention showing the circular blades within the body component in accordance with the disclosed architecture;

FIG. 4 illustrates a perspective view of one embodiment of the food slicing device of the present invention showing how meat is sliced thinly via the circular blades in accordance with the disclosed architecture;

FIG. 5 illustrates a perspective view of one embodiment of the food slicing device of the present invention in use in accordance with the disclosed architecture; and

FIG. 6 illustrates a flowchart showing the method of automatically thinly slicing meat and other foods with ease in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a food slicing device that provides users with a meat and other food slicing tool capable of cutting meat into thin strips. There is also a long felt need in the art for a food slicing device that allows users to prepare meat cooked in Japanese-style dishes with ease. Further, there is a long felt need in the art for a food slicing device that features a power button that activates a feeder mechanism and blades. Moreover, there is a long felt need in the art for a device that allows users to place meat and other foods on the feeder mechanism and allow it to be sliced thinly via the blades. Further, there is a long felt need in the art for a food slicing device that prevents users from having to thinly cut meat and other foods by hand, which can be difficult and time consuming. Finally, there is a long felt need in the art for a food slicing device that can be used with meat and other foods.

The present invention, in one exemplary embodiment, is a novel food slicing device for slicing meat and other foods in a thin, uniform manner. The food slicing device comprises a body component that is configured in a box-like enclosure for housing multiple circular blades within its interior. Further, the body component comprises a tapered opening on one side, which allows meat to be fed into the device and pushed flat against the circular blades. A feeder mechanism, which is a rolling tread, is used to move the meat through the circular blades. The device includes a power button, which rotates the circular blades, moves the feeder mechanism, and closes the tapered opening of the body component to protect a user. Users can insert meat into the tapered end and activate the device via the power button. The feeder mechanism is then activated and the meat is sent through the circular blades, and is sliced thinly. The present invention also includes a novel method of automatically thinly slicing meat and other foods with ease. The method includes the steps of providing a food slicing device comprising a body component with a circular blade and feeder mechanism. The method also comprises inserting meat into the body component. Further, the method comprises activating the device via the power button, which activates the circular blade and feeder mechanism. The method also comprises sending the meat through the circular blade for slicing via the feeder mechanism. Finally, the method comprises expelling the sliced meat from the body component and onto a tray for cooking.

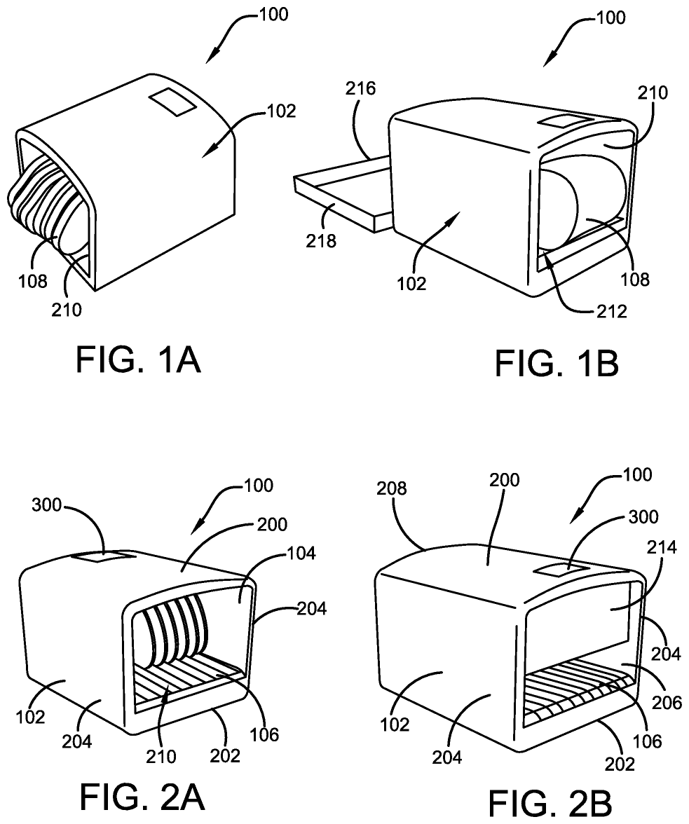

Referring initially to the drawings, FIGS. 1A-B illustrate a perspective view of one embodiment of the food slicing device 100 of the present invention. In the present embodiment, the food slicing device 100 is an improved food slicing device 100 that provides a user 110 with a tool for cutting meat 108 and other food in a thin, uniform manner for cooking. Specifically, the food slicing device 100 comprises a body component 102 which houses at least one circular blade 104 and a feeder mechanism 106. The feeder mechanism 106 is a rolling tread which is used to transport the meat 108 or other food through the circular blade 104 to be sliced.

Generally, the food slicing device 100 is a stand-alone unit of a conveniently small size which can be placed on a work surface 112, in a kitchen, in a household, or at some other location in the home, as desired. Alternatively, it can also be used in the meat section of a supermarket or grocery store, etc., or any other suitable place as is known in the art.

As shown in FIGS. 2A-B, the food slicing device 100 comprises a body component 102 that is configured in a box-like enclosure for housing multiple circular blades 104 within its interior 210. The body component 102 can be any suitable shape and size as is known in the art, as long as the body component 102 is sized to retain multiple circular blades 104 within its interior 210. Specifically, the body component 102 acts as a protective cover, to prevent injury from the blades 104, as well as to prevent any food 108 from being ejected from the blades 104 during the slicing process. Typically, the body component 102 is configured in a rectangular shape, with a top surface 200, a bottom surface 202, opposing front and back walls 204, and opposing right 206 and left 208 side openings, which form an open interior 210. The opposing right 206 and left 208 side openings allow access to the interior 210.

Further, the body component 102 comprises opposing right 206 and left 208 side openings, with the right side 206 being a tapered opening 212 for insertion of the meat 108 or other food to be sliced. Further, the tapered opening 212 allows meat 108 to be fed into the device 100 and pushed flat against the circular blades 104. Once the food 108 is inserted through the tapered opening 212 to be sliced, the tapered opening 212 is automatically closed to prevent user 110 injury from the active blades 104 via a sliding door 214. Specifically, the sliding door 214 acts to close off the tapered opening 212 and prevents users 110 from inserting their hands or other objects into the circular blades 104. Thus, the sliding door 214 is shaped and sized to completely close off the tapered opening 212 and slides up and down, as needed. Further, the left side 208 comprises an exit opening 216 for expelling the sliced food 108. Typically, the exit opening 216 comprises a tray 218 for catching the sliced food 108, once it has passed through the body component 102. However, a tray 218 is not necessary and the sliced food 108 would still be expelled through the exit opening 216 without it.

Additionally, the body component 102 houses multiple circular blades 104 within its interior 210, wherein the circular blades 104 are disc-like rotary blades. However, the circular blades 104 can be any suitable blades as is known in the art. Further, any suitable number of blades 104 can be utilized as is known in the art, as long as the blades 104 are able to effectively cut the food 108 that is being placed through the body component 102 into the required thin slices. Typically, the multiple circular blades 104 are secured within the interior 210 via an axle 220 positioned through the center 222 of the circular blades 104, which attaches by its ends 224 to the interior sidewalls (i.e., front and back walls 204). Generally, the circular blades 104 are of a rotary type. Specifically, the circular blades 104 are rotatably mounted along a shaft 220 that is generally parallel to the food's path through the body component 102.

Furthermore, the bottom interior surface 202 of the body component 102 comprises a feeder mechanism 106, which is a rolling tread which engages the product 108 and moves the same toward the circular blades 104. Specifically, the feeder mechanism 106 is a generally horizontal platform which acts to propel the food 108 through the body component 102 to be sliced by the circular blades 104. A user 110 would position the food 108 onto the feeder mechanism 106, and the feeder mechanism 106 would transport the food 108 through the body component 102, as needed. Accordingly, food, such as meat 108, moves along the feeder mechanism 106 until such product engages and is sliced by the circular blades 104 in order to form individual slices which are then expelled onto the tray 218 from the exit opening 216 and form stacks of product slices for subsequent cooking and meal prep.

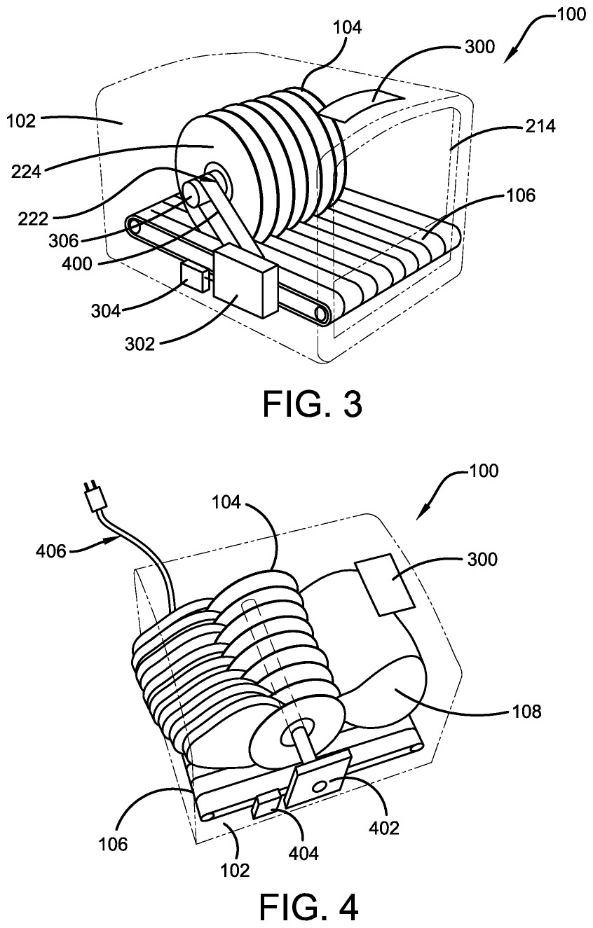

As shown in FIG. 3, the food slicing device 100 is a powered, automative food cutting device. The body component 102 comprises a power button 300, typically positioned on a top surface 200 but can be positioned in any suitable place on the body component 102. The power button 300 powers on and off the device 100 and acts to activate the motor 302 to rotate the circular blades 104 and activate the feeder mechanism 106 to transport food 108 through the body component 102, as well as to activate closing of the sliding door 214 on the tapered opening 212.

Furthermore, the food slicing device 100 comprises a motor 302, which is preferably an electric motor for rotating the circular blades 104. Further, the body component 102 comprises a controller 304 connected to the motor 302 to turn it on and off and control the motor speeds, if it's variable speed motor 302. In one embodiment, the motor 302 is connected to the circular blades 104 via a drive shaft 306. Specifically, the drive shaft 306 is connected to an axel 220 on the circular blades 104 either directly or indirectly to rotate the circular blades 104.

As shown in FIG. 4, as is customary with a food slicing device 100 such as that illustrated, the thickness of each slice will be a function of the speed at which the product 108 is fed to the circular blades 104, which blades 104 typically rotate at a constant speed. When the feeder mechanism 106 moves the product 108 into the circular blades 104 at a relatively fast speed, then the thickness of each slice is relatively thick since the product 108 moves across the plane of the blades 104 for an extended length as compared with the length of movement through the plane of the blades 104 when the product 108 is moving at a slower speed which would form thinner slices.

Further, in one embodiment, suitable drive mechanisms are provided including a main drive shaft 306, which is driven by the motor 302 through a timing belt 400. The drive shaft 306 extends into a drive box 402 which contains a mechanism for rotating the axel 220 of the cylindrical blades 104.

Additionally, the food slicer device 100 comprises a power source of a plurality of batteries 404, preferably rechargeable batteries. In another embodiment, the power source is a standard electrical outlet plug 406, however any suitable power source can be utilized as is known in the art, depending on the needs and/or wants of a user 110. Specifically, the power source is controlled by a power switch 300 which is in communication with the controller 304 to control the motor 302 to rotate the circular blades 104 to slice the food 108.

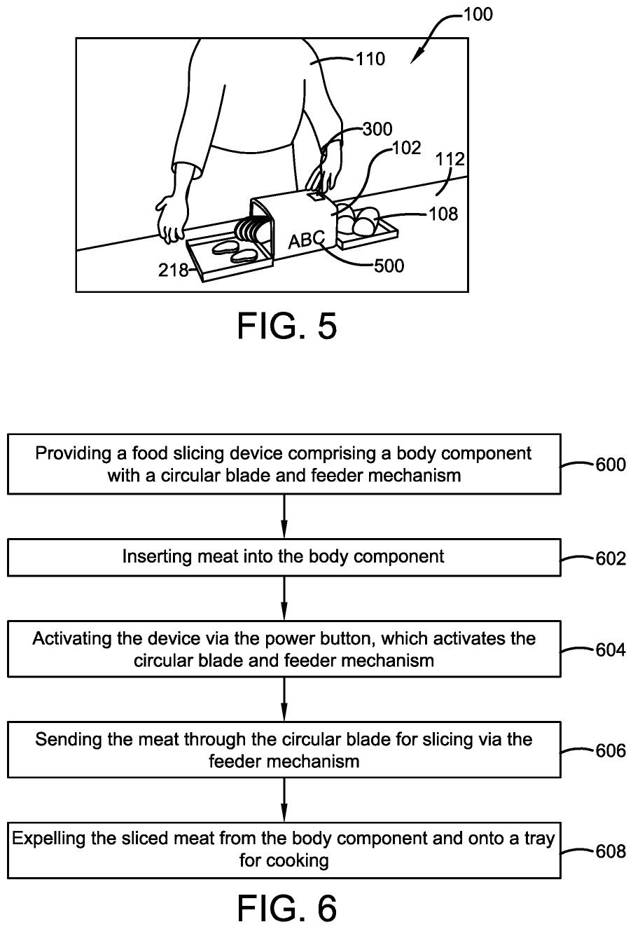

As shown in FIG. 5, the food slicing device 100 is manufactured of a metal material, such as stainless steel or aluminum, or polymers, such as acrylonitrile butadiene styrene (ABS) or polyurethane, etc. However, any other suitable food-grade materials (preferably of relatively light weight), such as galvanized, aluminum, polypropylene (PP) or polycarbonate (PC) may also be used.

In yet another embodiment, the food slicing device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be food slicer, food, or brand related.

In operation, users 110 can insert meat 108 into the tapered opening 212 and activate the device 100 via the power button 300. Once the power button 300 is depressed, the feeder mechanism 106 is activated and the meat 108 is sent through the circular blades 104 and is sliced thinly. Further, once the food 108 is inserted through the tapered opening 212 and the feeder mechanism 106 is activated, the tapered opening 212 is automatically closed via the sliding door 214. Once the meat 108 is passed through the circular blades 104, the sliced meat 108 is then expelled from the exit opening 216 of the body component 102 and onto a tray 218 for subsequent handling or consumption.

FIG. 6 illustrates a flowchart of the method of automatically thinly slicing meat and other foods with ease. The method includes the steps of at 600, providing a food slicing device comprising a body component with a circular blade and feeder mechanism. The method also comprises at 602, inserting meat into the body component. Further, the method comprises at 604, activating the device via the power button, which activates the circular blade and feeder mechanism. The method also comprises at 606, sending the meat through the circular blade for slicing via the feeder mechanism. Finally, the method comprises at 608, expelling the sliced meat from the body component and onto a tray for cooking.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “food slicing device”, “food device”, “slicing device”, and “device” are interchangeable and refer to the food slicing device 100 of the present invention.

Notwithstanding the forgoing, the food slicing device 100 of the present invention can be of any suitable size and configuration as is known in the art without affecting the overall concept of the invention, provided that it accomplishes the above stated objectives. One of ordinary skill in the art will appreciate that the food slicing device 100 as shown in FIGS. 1-6 is for illustrative purposes only, and that many other sizes and shapes of the food slicing device 100 are well within the scope of the present disclosure. Although the dimensions of the food slicing device 100 are important design parameters for user convenience, the food slicing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A food slicing device that cuts food in a thin, uniform manner for cooking, the food slicing device comprising:
a body component;
at least one circular blade; and
a feeder mechanism;
wherein the body component houses the at least one circular blade and the feeder mechanism; and
further wherein the feeder mechanism transports food through the at least one circular blade to be sliced.

2. The food slicing device of claim 1, wherein the food slicing device is a stand-alone unit of a conveniently small size which can be placed on a work surface for use.

3. The food slicing device of claim 2, wherein the body component is configured in a rectangular shape, with a top surface, a bottom surface, opposing front and back walls, and opposing right and left side openings, which form an open interior.

4. The food slicing device of claim 3, wherein the right side opening forms a tapered opening for insertion of the food to be sliced.

5. The food slicing device of claim 4, wherein the tapered opening comprises a sliding door that shuts after food is inserted through the tapered opening to be sliced.

6. The food slicing device of claim 5, wherein the left side opening forms an exit opening for expelling sliced food.

7. The food slicing device of claim 6, wherein the exit opening comprises a tray for catching the sliced food, once it has passed through the body component.

8. The food slicing device of claim 7, wherein the at least one circular blade are disc-like rotary blades, which are secured within the interior via an axle positioned through a center of the at least one circular blade, which attaches by its ends to interior sidewalls.

9. The food slicing device of claim 8, wherein the feeder mechanism is a rolling tread which engages the food and moves it toward the at least one circular blade.

10. The food slicing device of claim 9 further comprising a power button to power a motor to rotate the at least one circular blade and activate the feeder mechanism to transport food through the body component.

11. The food slicing device of claim 10, wherein the motor is connected to the at least one circular blade via a drive shaft, which is connected to the axel on the at least one circular blade either directly or indirectly to rotate the at least one circular blade.

12. The food slicing device of claim 11 further comprising a controller which controls the motor and the feeder mechanism.

13. A food slicing device that cuts food in a thin, uniform manner for cooking, the food slicing device comprising:
a body component configured in a rectangular shape, with a top surface, a bottom surface, opposing front and back walls, and opposing right and left side openings, which form an open interior;
at least one circular blade; and
a feeder mechanism;
wherein the food slicing device is a stand-alone unit of a conveniently small size which can be placed on a work surface for use;
wherein the right side opening forms a tapered opening for insertion of the food to be sliced;
wherein the tapered opening comprises a sliding door that shuts after food is inserted through the tapered opening to be sliced;
wherein the left side opening forms an exit opening for expelling sliced food;
wherein the exit opening comprises a tray for catching the sliced food, once it has passed through the body component;
wherein the at least one circular blade are disc-like rotary blades, which are secured within the interior via an axle positioned through a center of the at least one circular blade, which attaches by its ends to interior sidewalls;
wherein the feeder mechanism is a rolling tread which engages the food and moves it toward the at least one circular blade;
wherein a power button powers a motor to rotate the at least one circular blade and activate the feeder mechanism to transport food through the body component;
wherein the motor is connected to the at least one circular blade via a drive shaft, which is connected to the axel on the at least one circular blade either directly or indirectly to rotate the at least one circular blade;
wherein a controller controls the motor and the feeder mechanism; and
further wherein the body component houses the at least one circular blade and the feeder mechanism.

14. The food slicer device of claim 13, wherein thickness of each slice will be a function of speed at which the food is fed to the at least one circular blade.

15. The food slicer device of claim 14, wherein the at least one circular blade typically rotates at a constant speed.

16. The food slicer device of claim 13, wherein suitable drive mechanisms are provided including a main drive shaft, which is driven by the motor through a timing belt, wherein the drive shaft extends into a drive box which contains a mechanism for rotating the axel of the at least one cylindrical blade.

17. The food slicer device of claim 13, wherein a power source is a plurality of batteries or a standard electrical outlet plug.

18. The food slicing device of claim 13, wherein the food slicing device is manufactured of a food-grade material.

19. The food slicing device of claim 13 further comprising a plurality of indicia.

20. A method of automatically thinly slicing meat and other foods with ease, the method comprising the following steps:
providing a food slicing device comprising a body component with a circular blade and feeder mechanism;
inserting meat into the body component;
activating the device via the power button, which activates the circular blade and feeder mechanism;
sending the meat through the circular blade for slicing via the feeder mechanism; and
expelling the sliced meat from the body component and onto a tray for cooking.
